(19) United States
(12) Patent Application Publication
(10) Pub. No.: US 2025/0243076 A1
(43) Pub. Date: Jul. 31, 2025

(54) METHOD AND SYSTEM FOR FIXING CARBON DIOXIDE

(71) Applicant: TOYOTA JIDOSHA KABUSHIKI KAISHA, Toyota-shi (JP)

(72) Inventors: Koseki SUGIYAMA, Sunto-gun (JP); Yoshiteru YAZAMA, Nagoya-shi (JP); Akira KATO, Toyota-shi (JP); Masahiko TAKEUCHI, Toyota-shi (JP); Yuki TAKAHASHI, Miyoshi-shi (JP)

(73) Assignee: TOYOTA JIDOSHA KABUSHIKI KAISHA, Toyota-shi (JP)

(21) Appl. No.: 18/934,391

(22) Filed: Nov. 1, 2024

(30) Foreign Application Priority Data
Jan. 26, 2024 (JP) 2024-010534

(51) Int. Cl. C01F 11/18; C01F 5/24; C02F 1/469; C02F 101/10; C02F 103/08

(52) U.S. Cl. CPC C01F 11/18; C01F 5/24; C02F 1/4693; C02F 2101/10; C02F 2103/08

(57) ABSTRACT

A method for fixing carbon dioxide according to the present disclosure includes: capturing carbon dioxide from seawater at a direct ocean capture (DOC) facility; concentrating a mineral source in seawater at the DOC facility; supplying the captured carbon dioxide to the mineral source; supplying carbon dioxide obtained outside the DOC facility to the mineral source; and mixing the carbon dioxide captured at the DOC facility and the carbon dioxide supplied from outside the DOC facility with the mineral source to carbonate the mineral source.

### CROSS-REFERENCE TO RELATED APPLICATION

This application claims priority to Japanese Patent Application No. 2024-010534 filed on Jan. 26, 2024, incorporated herein by reference in its entirety.

### BACKGROUND

### 1. Technical Field

The present disclosure relates to methods and systems for fixing carbon dioxide.

### 2. Description of Related Art

WO 2022/99174 discloses an electrodialysis system for capturing carbon dioxide (CO₂) that is a greenhouse gas from ocean water. The electrodialysis system of WO 2022/99174 acidifies ocean water to capture carbon dioxide. A separation membrane separates carbon dioxide gas from the acidified liquid.

### SUMMARY

Carbon dioxide can be fixed using mineral sources such as calcium (Ca) and magnesium (Mg). For example, carbon dioxide can be fixed by causing carbon dioxide to react with the mineral sources to carbonate the mineral sources. Carbon dioxide can be fixed by producing carbonates such as calcium carbonate (CaCO₃), magnesium carbonate (MgCO₃), or a double salt thereof (CaMg(CO₃)₂).

Development of a more efficient carbon dioxide fixation technique has been urgently needed. For example, mineral sources for fixation can be concentrated at direct ocean capture (DOC) facilities. However, the amount of carbon dioxide contained in seawater is less than the amount of magnesium and calcium contained in seawater. For example, the amount of calcium and magnesium that can be obtained from a unit volume of seawater is much larger than the amount of carbon dioxide gas that can be obtained from a unit volume of seawater. Therefore, it is difficult to efficiently fix carbon dioxide.

The present disclosure was made in view of the above issue, and an object of the present disclosure is to provide a carbon dioxide fixation method and carbon dioxide fixation system that can efficiently fix carbon dioxide.

In order to solve the above issue and achieve the object, the present disclosure provides the following method and system for fixing carbon dioxide.

A method for fixing carbon dioxide according to the present disclosure includes:
capturing carbon dioxide from seawater at a DOC facility;
concentrating a mineral source in seawater at the DOC facility;
supplying the captured carbon dioxide to the mineral source;
supplying carbon dioxide obtained outside the DOC facility to the mineral source; and
mixing the carbon dioxide captured at the DOC facility and the carbon dioxide supplied from outside the DOC facility with the mineral source to carbonate the mineral source.

A system for fixing carbon dioxide according to the present disclosure includes:
a capture unit that captures carbon dioxide from seawater at a DOC facility;
a seawater concentration unit that concentrates a mineral source in seawater at the DOC facility;
a supply unit that supplies carbon dioxide obtained outside the DOC facility to the mineral source; and
a fixation unit that mixes the carbon dioxide supplied from the supply unit with the mineral source to carbonate the mineral source.

According to the present disclosure, it is possible to provide a carbon dioxide fixation method and carbon dioxide fixation system that can efficiently fix carbon dioxide.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an entire configuration of a DOC facility;

FIG. 2 is a block diagram illustrating an overall configuration of a fixation system according to a first embodiment;

FIG. 3 is a schematic diagram for explaining a bipolar membrane electrodialysis method;

FIG. 4 is a flow chart showing a carbon dioxide fixation process; and

FIG. 5 is a block diagram illustrating an overall configuration of a fixation system according to a second embodiment.

### DETAILED DESCRIPTION OF EMBODIMENTS

Hereinafter, embodiments of the present disclosure will be described with reference to the drawings. However, the disclosure according to the claims is not limited to the following embodiments. Moreover, all of the configurations described in the embodiments are not necessarily indispensable as means for solving the issue. In order to clarify the explanation, the following description and drawings have been omitted or simplified as appropriate. In each drawing, the same elements are designated by the same reference signs, and duplicate explanations are omitted as necessary.

### First Embodiment

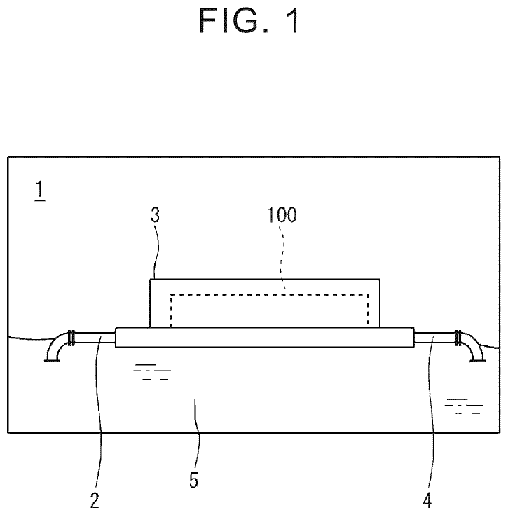

A fixation system according to the present embodiment will be described with reference to FIG. 1. FIG. 1 is a schematic diagram illustrating an entire configuration of a DOC facility 1. At least a part of a carbon dioxide (CO₂) fixation system 100 according to the present embodiment is provided in DOC facility 1.

As shown in FIG. 1, DOC facility 1 is a floating facility that floats on the sea. DOC facility 1 includes a water supply pipe 2, a capture facility 3, and a drain pipe 4. The leading ends of the water supply pipe 2 and the drain pipe 4 are immersed in the sea. The capture facility 3 is floating at sea.

The water supply pipe 2 sucks the seawater 5 in the shallow region of the sea and supplies it to the capture facility 3. The water supply pipe 2 may be provided with a pump or the like for sucking the seawater 5. The capture facility 3 captures carbon dioxide in seawater. The capture facility 3 has a fixation system 100 for fixing the carbon dioxide absorbed in the seawater 5. The fixation system 100 will be described later.

The drain pipe 4 discharges the seawater from which the carbon dioxide has been captured to the sea. The capture facility 3 extracts the carbon dioxide in the seawater 5, thereby lowering the carbon dioxide concentration in the seawater. Seawater having a low concentration of carbon dioxide passes through the drain pipe 4 and returns to the sea. The capture facility 3 can capture the carbon dioxide in the seawater by fixing the carbon dioxide to the mineral source.

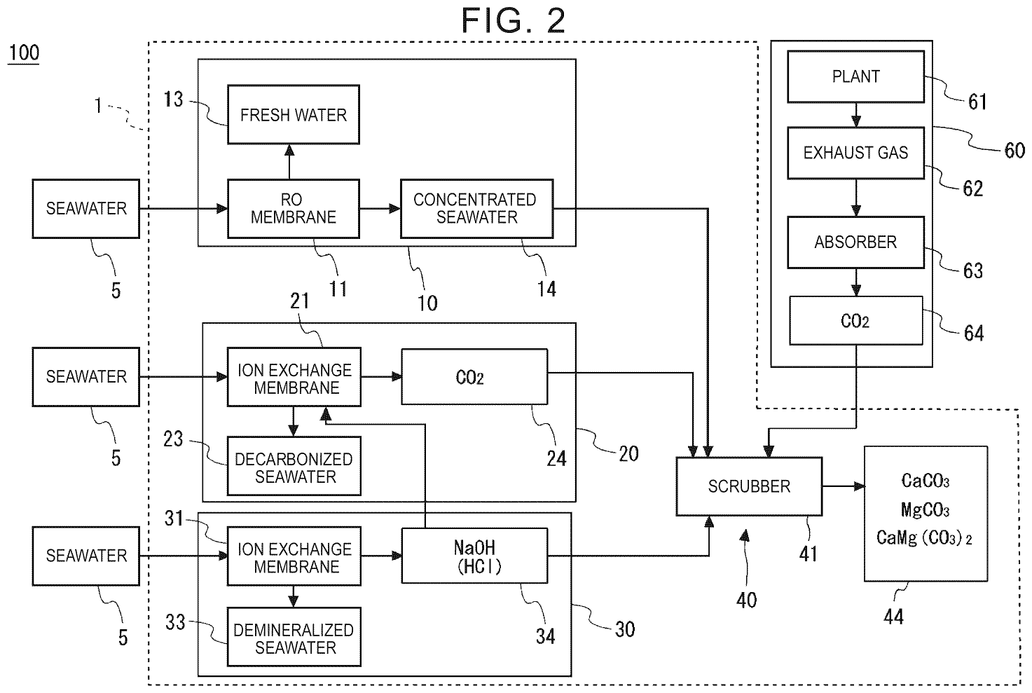

FIG. 2 is a block diagram illustrating a configuration of the fixation system 100. As illustrated in FIG. 2, the fixation system 100 includes a seawater concentration unit 10, a capture unit 20, an extraction unit 30, a fixation unit 40, and a supply unit 60. The seawater concentration unit 10, the capture unit 20, the extraction unit 30, and the fixation unit 40 are provided in DOC facility 1. The supply unit 60 is provided in an external facility outside DOC facility 1.

The seawater concentration unit 10 is provided with a RO (Reverse Osmosis membrane) 11 for concentrating seawater. RO (Reverse Osmosis membrane) 11 is a reverse-osmosis membrane that permeates only water molecules and does not permeate materials dissolved in water. Seawater permeates through RO membrane 11, resulting in fresh water 13. The fresh water 13 may be returned to the sea or may be used as coolant etc.

Furthermore, in seawater that does not permeate through RO membrane 11, mineral sources such as calcium/magnesium are concentrated. The seawater in which the mineral source is concentrated is referred to as concentrated seawater 14. As described above, by using RO film 11, concentrated seawater and fresh water are generated. Concentrations of calcium and magnesium are higher in concentrated seawater than in seawater. The seawater concentration unit 10 concentrates mineral sources such as calcium and magnesium from the seawater 5. Then, the seawater concentration unit 10 supplies the concentrated seawater 14 to the fixation unit 40.

The extraction unit 30 extracts sodium hydroxide 34 (hereinafter also referred to as NaOH) from the seawater 5. For example, the extraction unit 30 includes an ion exchange membrane 31. Specifically, NaOH is extracted from the seawater 5 by electrodialysis using the ion-exchange membrane 31. By using the electrodialysis method, NaOH is precipitated. The seawater from which NaOH has been extracted becomes demineralized seawater 33. NaOH is supplied to the fixation unit 40 to adjust pH.

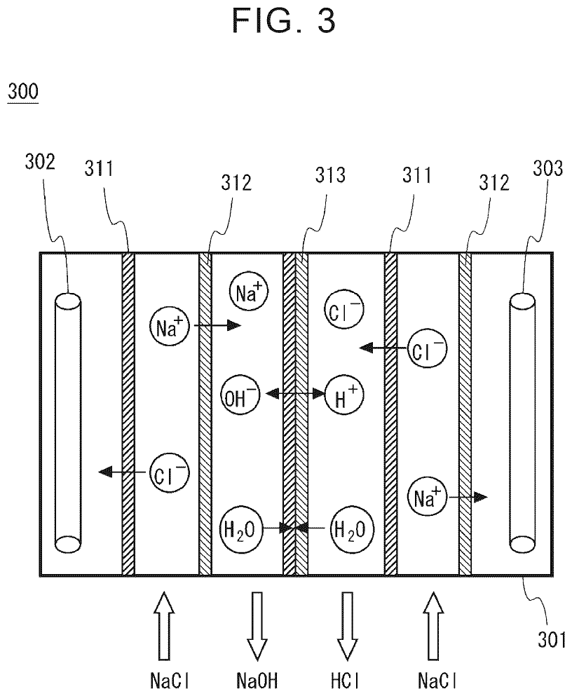

For example, NaOH, and hydrochloric acid (HCl) are extracted by Bipolar Membrane Electrodialysis (BMED) using an anion-exchange membrane, a cation-exchange membrane, and a bipolar membrane. FIG. 3 is a schematic diagram for explaining the electrodialysis apparatus 300 of the bipolar membrane electrodialysis method.

The storage tank 301 is a tank for storing seawater 5 containing sodium chloride (NaCl). The storage tank 301 is provided with an anode 302 and a cathode 303. In the storage tank 301, an anion exchange membrane 311, a cation exchange membrane 312, and a bipolar membrane 313 are disposed between the anode 302 and the cathode 303. From the anode 302 side, an anion exchange membrane 311, a cation exchange membrane 312, a bipolar membrane 313, an anion exchange membrane 311, and a cation exchange membrane 10 312 are arranged in this order.

Seawater containing NaCl is supplied to the compartment between the anion exchange membrane 311 and the cation exchange membrane 312. The anion exchange membrane 311 passes through the anions and blocks the passage of cations. Therefore, Cl⁻ in the seawater passes through the anion-exchange membrane 311 toward the anode 302. The cation exchange membrane 312 passes through the cations and blocks the passage of anions. Therefore, Na⁺ in the seawater passes through the cation-exchange membrane 312 toward the cathode 303.

The bipolar membrane 313 is an ion exchange membrane in which the anion exchange membrane 311 and the cation exchange membrane 312 are bonded to each other. The bipolar membrane 313 dissociates water molecules (H₂O) into H⁻ and OH⁻ by application of a voltage. The H⁺ migrates to the compartment between the bipolar membrane 313 and the anion-exchange membrane 311. OH⁻ migrates to the compartment between the cation-exchange membrane 312 and the bipolar membrane 313. Accordingly, HCl is extracted from the compartment between the bipolar membrane 313 and the anion-exchange membrane 311. NaOH is extracted from the compartment between the cation-exchange membrane 312 and the bipolar membrane 313.

As shown in FIG. 2, NaOH for making pH alkaline is supplied to the fixation unit 40. Further, NaOH may be supplied to the capture unit 20. Further, HCl for acidifying pH may be supplied to the capture unit 20. The extraction unit 30 is not limited to the electrodialysis method, and may extract NaOH by electrolysis of seawater.

The capture unit 20 captures carbon dioxide 24 (hereinafter, also referred to as CO₂) from the seawater 5. The capture unit 20 includes an ion-exchange membrane 21 for capturing CO₂. For example, the capture unit 20 captures CO₂ by electrodialysis using the ion-exchange membrane 21. Anion exchange membranes, cation exchange membranes, and Bipolar Membrane Electrodialysis (BMED) using bipolar membranes can be utilized. Specifically, CO₂ is captured using the technique described in WO 2022/99174.

Further, the capture unit 20 can capture the carbon dioxide 24 as CO₂ gases by lowering pH of the seawater. For example, the capture unit 20 supplies HCl to the seawater 5 to make the seawater 5 acidic. Alternatively, the capture unit 20 increases pH of the seawater, so that the carbon dioxide becomes carbonate. That is, by supplying sodium hydroxide 34 to the seawater, the seawater 5 becomes alkaline. In this case, carbonate ions are produced. Therefore, when a mineral source such as Mg or Ca is contained in the seawater, it is precipitated as carbonate.

The supply unit 60 supplies gases containing carbon dioxide (CO₂) to the fixation unit 40. For example, the supply unit 60 supplies the carbon dioxide 64 contained in the exhaust gas 62 generated in the factory 61 to the fixation unit 40. For example, the factory 61 on the ground is discharged by the exhaust gas 62. The exhaust gas 62 is, for example, combustion gas generated when the hydrocarbon-based fuel is burned. The exhaust gas 62 contains, for example, carbon dioxide gas at a high concentration of 10 to 15%.

The absorber 63 absorbs the carbon dioxide gas contained in the exhaust gas 62. The absorber 63 includes a solid adsorbent and a porous carrier. The solid adsorbent is supported on a porous support. When the exhaust gas 62 comes into contact with the absorber 63, the absorber 63 adsorbs carbon dioxide in the exhaust gas 62. Here, the porous support on which the solid adsorbent is supported is not particularly limited, but is coated on, for example, a substrate having a honeycomb structure.

The solid adsorbent is not particularly limited, but is, for example, a hydrophilic polymer, and more particularly, an amine-based polymer such as polyethyleneimine, a primary amine, a secondary amine, or a secondary alkanolamine.

In the supply unit 60, a gas containing carbon dioxide 64 is extracted from the absorber 63. For example, the absorber 63 is placed under reduced pressure and heated. As a result, the gas containing the carbon dioxide 64 absorbed by the absorber 63 is released. The carbon dioxide gas discharged from the absorber 63 is supplied to the fixation unit 40.

Gases containing carbon dioxide 64 from the supply unit 60 are supplied to DOC facilities 1 through pipes and the like. By adjusting the heating temperature and the pressure, a gas having a desired carbon dioxide concentration can be taken out from the absorber 63. The supply unit 60 can supply a high concentration of carbon dioxide gas to the fixation unit 40 by using the absorber 63.

Here, the carbon dioxide gas contained in the exhaust gas 62 is supplied to the fixation unit 40 via the absorber 63, but the exhaust gas 62 may be directly supplied to the fixation unit 40. For example, the exhaust gas 62 containing carbon dioxide gas may be supplied to the fixation unit 40 through a pipe installed between the factory 61 and the fixation unit 40.

As described above, the concentrated seawater 14, the carbon dioxide 24, and the carbon dioxide 64 are supplied to the fixation unit 40. The fixation unit 40 includes a scrubber 41. The concentrated seawater 14, the carbon dioxide 24, and the carbon dioxide 64 are supplied to the scrubber 41. The scrubber 41 performs exhaust gas treatment using the concentrated seawater 14 containing carbon dioxide gas as a treatment liquid. The scrubber 41 mixes the carbon dioxide 24 and the carbon dioxide 64 into the concentrated seawater 14 to fix the carbon dioxide. That is, the scrubber 41 reacts calcium or magnesium with carbon dioxide to produce the carbonate 44. That is, the scrubber 41 mixes the carbon dioxide gas and the concentrated seawater 14 to carbonate calcium and magnesium.

For example, the scrubber 41 includes a tank for storing concentrated seawater 14, an inlet for introducing carbon dioxide gas is connected, and a nozzle for generating bubbles in the scrubber 41. By the operation of the scrubber 41, carbon dioxide is fixed to the mineral source contained in the concentrated seawater 14. That is, carbonate 44 such as calcium carbonate (CaCO₃), magnesium carbonate (MgCO₃), and calcium magnesium carbonate (CaMg(CO₃)₂) is produced. Accordingly, the carbon dioxide 24 contained in the seawater and the carbon dioxide 64 contained in the air can be fixed.

The fixation unit 40 fixes carbon dioxide to the mineral source contained in the concentrated seawater 14. Concentrated seawater 14 has a higher concentration of calcium and magnesium than normal seawater. Since the concentration of the mineral source is high in the concentrated seawater 14, it is possible to efficiently fix carbon dioxide.

A supply unit 60 in an external facility of DOC facility 1 supplies gases containing carbon dioxide to the fixation unit 40. The supply unit 60 supplies a gas having a high carbon dioxide concentration to the scrubber 41. The scrubber 41 mixes the carbon dioxide gas with the concentrated seawater 14 to produce carbonates. The fixation unit 40 can efficiently fix carbon dioxide to calcium or magnesium. A mixture containing a high concentration of carbon dioxide gas is treated with a scrubber 41. Therefore, carbonates such as calcium carbonate, magnesium carbonate, and calcium magnesium carbonate can be efficiently produced.

For example, the amount of carbon dioxide 24 captured from only the seawater 6 in DOC facility 1 is smaller than that of the mineral source. The supply unit 60 can compensate for the shortage by supplying the shortage of the carbon dioxide 24 from the outside. That is, the carbon dioxide 64 is supplied from an external facility to the mineral source excessively obtained from the seawater 5. This allows an excess of mineral source to be used for fixation. Since the carbon dioxide can be efficiently fixed, the reduction amount of the carbon dioxide can be increased.

Further, NaOH extracted by the extraction unit 30 is supplied to the fixation unit 40. By supplying NaOH to the concentrated seawater 14, pH of the mixed liquid can be adjusted. NaOH may be supplied as solids to the concentrated seawater 14 or as an aqueous solution. Here, NaOH is added to the concentrated seawater 14 so that pH of the concentrated seawater 14 is equal to or greater than 12. The scrubber 41 generates bubbles in a mixed liquid in which NaOH and carbon dioxide gases are mixed in the concentrated seawater 14.

By making pH of the mixed liquid alkaline, it is possible to efficiently fix carbon dioxide. The higher pH of the admixture, the lower the solubility of the carbonate. In particular, when pH is 12 or more, the solubility is extremely low. Therefore, NaOH is added to the concentrated seawater 14 so that pH of the mixed liquid is 12 or more. As a result, more carbonate 44 can be precipitated from the concentrated seawater, so that the carbon dioxide can be efficiently fixed. Calcium carbonate, magnesium carbonate, or the like may be used as an industrial raw material. Alternatively, it may be stored underground or in the sea as a carbonate mineral.

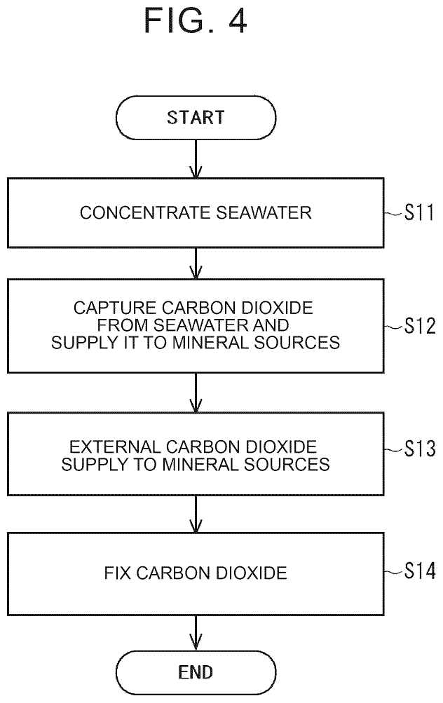

FIG. 4 is a flow chart illustrating a method for fixing carbon dioxide. First, the seawater concentration unit 10 concentrates the seawater 5 (S11). The seawater concentration unit 10 concentrates the mineral source in the seawater 5 using RO film 11. The seawater concentration unit 10 supplies the concentrated seawater 14 in which the mineral source is concentrated to the fixation unit 40.

Next, the capture unit 20 captures the carbon dioxide 24 from the seawater 5 and supplies it to the mineral source (S12). The capture unit 20 may supply carbon dioxide as a gas, or may supply carbon dioxide gas as a liquid dissolved in the seawater 5.

The supply unit 60 supplies carbon dioxide to the mineral source from the outside of DOC facility 1 (S13). Here, the supply unit 60 supplies the carbon dioxide gas contained in the exhaust gas 62 discharged from the factory 61 to the fixation unit 40.

The fixation unit 40 fixes carbon dioxide to the mineral source (S14). Specifically, the scrubber 41 processes the concentrated seawater 14 containing carbon dioxide. The scrubber 41 mixes the carbon dioxide 24, 64 with the concentrated seawater 14 to produce carbonate. In this way, the carbon dioxide can be efficiently fixed.

In the capturing step S12 and the fixing step S14, pH of the seawater may be adjusted. For example, when the extraction unit 30 supplies NaOH to the concentrated seawater 14, the concentrated seawater 14 becomes alkaline. Here, it is preferable to add NaOH so that pH of the mixed liquid is 12 or more. In addition, pH of the seawater 5 may be adjusted in the capture unit 20. For example, HCl is added to seawater 5 to extract carbon dioxide as gases. As a result, the seawater 5 becomes acidic.

The facility that emits exhaust gas is not limited to a factory. That is, Not limited to the factory 61, the carbon dioxide 64 may be supplied from various plants such as power generation plants, chemical plants, petroleum plants, gas plants, plant plants, iron-making plants, and mining plants.

### Second Embodiment

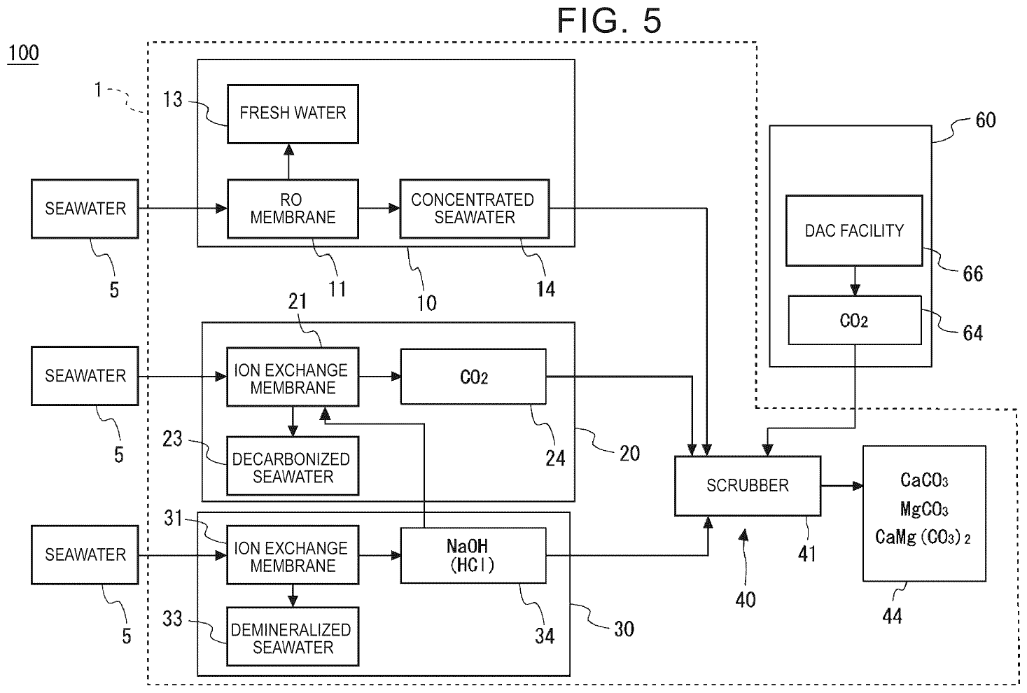

The fixation method and the fixation system according to the second embodiment will be described with reference to FIG. 5. FIG. 5 is a block diagram showing an overall configuration of the fixation system. In the second embodiment, the configuration of the supply unit 60 is different from that of the first embodiment. Configurations other than the supply unit 60 are the same as those of the first embodiment, and thus description thereof will be omitted as appropriate.

The supply unit 60 supplies the carbon dioxide from DAC facility 66 to the fixation unit 40. DAC facilities 66 concentrate, for example, carbon dioxide gases in the atmosphere. DAC facilities 66 include air-collecting fans, a separating membrane for separating carbon dioxide gas, and the like. The separation membrane is formed of a polymer membrane, an ionic liquid membrane, or the like. The separation membrane selectively transmits carbon dioxide. In DAC facilities 66, the separating membranes may be arranged in multiple stages. In this manner, DAC facilities 66 provide concentrated carbon dioxide gases. The carbon dioxide 64 is a gas containing carbon dioxide gas having a concentration higher than the concentration of carbon dioxide gas in the atmosphere

Then, the supply unit 60 supplies the carbon dioxide 64 as a gas to the fixation unit 40. A gas containing the concentrated carbon dioxide gas is supplied to the fixation unit 40. Carbonate 44 is produced by mixing carbon dioxide 64 from DAC facility with concentrated seawater 14. Thus, the fixation unit 40 can fix the carbon dioxide 24 contained in the seawater and the carbon dioxide 64 contained in the air to the mineral source.

Also in the fixation system 100 of the present embodiment, as described in Embodiment 1, carbon dioxide contained in the exhaust gas 62 such as the factory 61 may be supplied to the fixation unit 40. That is, there may be two or more external facilities that supply carbon dioxide. Carbon dioxide gas may be supplied to the fixation unit 40 from two or more different facilities, or carbon dioxide gas may be supplied to the fixation unit 40 from two or more locations of one facility.

The present disclosure is not limited to the above embodiments, and can be appropriately modified without departing from the spirit. It also contributes to carbon neutral, decarbonization, Sustainable Development Goals (SDGs).

What is claimed is:

1. A method for fixing carbon dioxide, the method comprising:
capturing carbon dioxide from seawater at a direct ocean capture facility;
concentrating a mineral source in seawater at the direct ocean capture facility;
supplying the captured carbon dioxide to the mineral source;
supplying carbon dioxide obtained outside the direct ocean capture facility to the mineral source; and
mixing the carbon dioxide captured at the direct ocean capture facility and the carbon dioxide supplied from outside the direct ocean capture facility with the mineral source to carbonate the mineral source.

2. The method according to claim 1, wherein the carbon dioxide obtained from outside the direct ocean capture facility is supplied to the mineral source as a gas having a higher carbon dioxide concentration than an atmospheric carbon dioxide concentration.

3. The method according to claim 1, wherein the carbon dioxide obtained from outside the direct ocean capture facility is carbon dioxide gas contained in exhaust gas from a plant or a factory.

4. The method according to claim 1, wherein the carbon dioxide obtained from outside the direct ocean capture facility is supplied from a direct air capture facility.

5. A system for fixing carbon dioxide, the system comprising:
a capture unit that captures carbon dioxide from seawater at a direct ocean capture facility;
a seawater concentration unit that concentrates a mineral source in seawater at the direct ocean capture facility;
a supply unit that supplies carbon dioxide obtained outside the direct ocean capture facility to the mineral source; and
a fixation unit that mixes the carbon dioxide supplied from the supply unit with the mineral source to carbonate the mineral source.
